(19) United States
(12) Patent Application Publication
(10) Pub. No.: US 2023/0051482 A1
(43) Pub. Date: Feb. 16, 2023

(54) Battery Rotation System For Rechargeable Batteries

(71) Applicant: Flow-Rite Controls, Ltd., Byron Center, MI (US)

(72) Inventor: Mark W. Herrema, Rockford, MI (US)

(21) Appl. No.: 17/400,713

(22) Filed: Aug. 12, 2021

(51) Int. Cl. B60L 58/18; B60L 53/63; B60L 53/65; B60L 53/68

(52) U.S. Cl. CPC B60L 58/18; B60L 53/63; B60L 53/65; B60L 53/68

(57) ABSTRACT

A battery rotation system for rechargeable batteries. The system includes a plurality of battery monitors each configured to mount to a rechargeable battery, each connected to the terminals of the battery, and each including a current sensor, a voltage sensor, and a temperature sensor. The system further includes a server in wireless communication with the battery monitors to receive battery status information from the monitors. When a battery is connect to a battery charger, the battery monitor determines when the battery is ready for use. The server maintains queue information of available batteries and sends that information to a remote user device. The server also can schedule battery replacements and schedule charging times based on peak hours.

### BACKGROUND OF THE INVENTION

The present invention relates to systems and methods for charging wet cell batteries.

Wet cell batteries, also known as flooded cell batteries are widely used in a variety of applications. One application is industrial vehicles or industrial trucks, such as forklifts. A single industrial truck typically is powered by multiple batteries. With use, the batteries become discharged; and consequently the batteries must be charged or recharged. So that the truck can continue in service, most typically the discharged batteries are removed from the truck; and a different charged batteries are installed in the truck. The discharged batteries are connected to a charger or charging system, so that they can be used by another industrial truck at a later time.

As the batteries are charged, they typically heat to a temperature above ambient temperature. Excessive heat can damage the batteries, so typically the batteries are allowed to cool to their rated temperature following charging and before they are reused. For example, the batteries might be used by the industrial truck for 8 hours, charged for 8 hours, and allowed to cool for 8 hours. These times can vary greatly for example based on the battery condition, and this variation leads to uncertainty regarding when a particular battery may be properly available for use again. Use of “standard” times may lead to batteries being inadequately charged and/or inadequately cooled before reuse.

In efforts to accommodate this uncertainty, battery rotation systems have been developed. One such system includes the hardwiring of application-specific battery-monitoring hardware to each battery charger to create a hardwired communication and monitoring network. The hardware monitors the battery during the charging process and determines (a) when the charging process is complete and (b) when the battery is sufficiently cooled, signaling to an operator when batteries are ready to be used.

Known systems include the installation of hardware on every battery charger. This results in a large upfront implementation cost. Additionally, if additional batteries or chargers are added to the system after installation, the charging infrastructure must be reconfigured, which further increases the cost of the system. Further, in order to move or rearrange the battery charging system within a battery room, the hardware infrastructure needs to be reworked and/or new infrastructure needs to be installed, which can be costly.

### SUMMARY OF THE INVENTION

In one aspect, a battery rotation system for rechargeable batteries includes a plurality of battery mount monitor assemblies, each mounted on a rechargeable battery. Each assembly can include a current sensor, a voltage sensor, and a temperature sensor. Based on the sensed parameters during charging and cooling, each assembly (a) may determine battery rotation information for the battery on which the assembly is mounted and (b) may communicate the battery rotation information to a remote device. In one aspect, the battery rotation information includes an indication of whether the battery is ready for use. The remote device may communicate the battery rotation information to a remote server, or the assemblies may communicate directly with the remote server. If the battery rotation information for a battery indicates that the battery is ready for use, the remote server may add the battery to a queue of available batteries. The remote server can communicate the queue of available batteries to one or more remote user devices.

In one aspect, the remote server can calculate a number of available batteries based on the queue of available batteries. Upon receiving a request for batteries, the remote server can determine whether it is possible to fulfill that request based on the calculated number of available batteries. The remote server may then communicate that determination to the remote user device.

In one aspect, the remote server (a) can receive the battery status information for the batteries installed in a vehicle and (b) may determine an amount of energy remaining in the batteries. The remote server can schedule a replacement time for one or all of the batteries based on the battery status information and the calculated total number of available batteries.

In one aspect, the remote server can determine whether the battery rotation system has a sufficient number of batteries. The remote server may receive at least one request for an available battery and may calculate the total number of requested batteries based on the requests. The remote server may determine a difference between the total of available batteries and the number of requested batteries and compare that difference with a set threshold. Depending on this comparison, the remote server can determine whether the battery rotation system has a surplus of charged batteries, a deficit of charged batteries, or an appropriate number of charged batteries.

In one aspect, the remote server may cause a battery to be charged outside of peak hours. The remote server can receive the battery status information from a rechargeable battery indicating the battery has been connected to a battery charger. The remote server may then determine the time of day when the battery was connected to the battery charger and whether that time is within a given set of peak hours. If the time is within the set of peak hours, the remote server can determine whether the battery may be charged outside the set of peak hours based on the demand for the battery. If the battery can be charged outside the set of peak hours, the remote server can instruct the battery mount monitor assembly to prevent the battery charger from charging the battery until outside the set of peak hours.

These and other advantages and features of the invention will be more fully understood and appreciated by reference to the description of the current aspects and the drawings.

### BRIEF DESCRIPTION OF THE DRAWINGS

FIG. 1 is a perspective view of a battery mount monitor assembly according to one aspect;

FIG. 2 is a perspective view of a gateway according to one aspect;

FIG. 3 is a schematic diagram of a battery rotation system according to one aspect;

FIGS. 4A-4B are flowcharts illustrating an algorithm for the operation of a battery rotation system according to one aspect;

FIG. 5 is a flowchart illustrating an algorithm for scheduling battery changes according to one aspect;

FIG. 6 is a flowchart illustrating an algorithm for determining whether a battery rotation system has a desired number of batteries according to one aspect;

FIGS. 7A-7B are flowcharts illustrating an algorithm for delaying a charging event to outside a set of peak hours where appropriate according to one aspect;

FIG. 8 is a system diagram of a battery rotation system according to one aspect; and

FIG. 9 is a perspective view of a battery rotation system according to one aspect.

### DESCRIPTION OF THE CURRENT ASPECTS

Various aspects of a battery rotation system including a plurality of battery mount monitor assemblies and a network-connected gateway are shown and described herein.

Before the aspects of the invention are explained in detail, it is to be understood that the invention is not limited to the details of operation or to the details of construction and the arrangement of the components set forth in the following description or illustrated in the drawings. The invention may be implemented in various other aspects and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various aspects. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

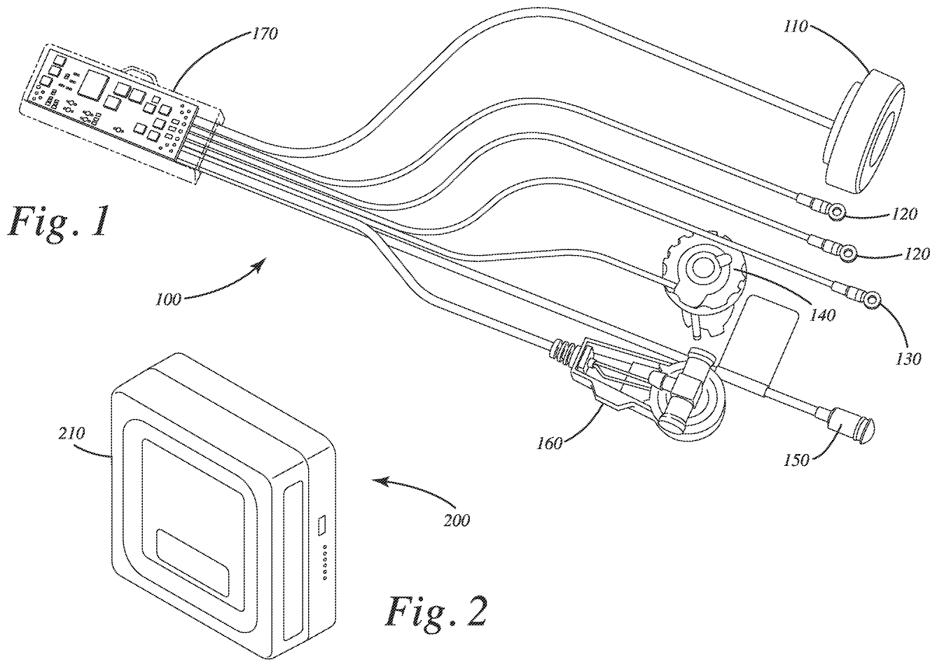

In FIG. 1, an exemplary battery mount monitor assembly 100 is shown. The battery mount monitor assembly 100 may include a battery current sensor 110, a set of power leads 120, a half-voltage ground wire 130, a probe 140, an indicator light 150, a pressure sensor 160, and a battery monitor control module 170. The battery mount monitor assembly 100 can be directly installed on an individual battery. Put another way, the battery mount monitor assembly 100 can be integrated into the battery such that the battery mount monitor assembly 100 and the battery move as one unit. To install the battery current sensor 110, it may be placed around a positive power cable connected to a battery and slid down toward a battery post (not shown). The current sensor 110 may be situated alongside the battery post or on a different portion of the positive power cable. The power leads 120 may include a positive battery lead and a negative battery lead and be coupled to the respective positive and negative posts of the battery. In one aspect, the half-voltage ground wire 130 may be coupled to the battery toward the center of the battery. In the depicted aspect, the probe 140 is incorporated into a valve. The probe 140 can be installed in the battery by installing the valve in a pre-existing aperture in the battery. In an alternative aspect, the probe 140 is not integrated into a valve, and a hole can be drilled into a desired cell of the battery and the probe 140 may be inserted into the hole. The pressure sensor 160 can be installed by removing a cap from a valve's hose and installing a hose of the pressure sensor 160 where the cap was removed. In one aspect, the battery may have multiple cells. The battery monitor control module 170 may be placed next to an inter-cell connector. The indicator light 150 can be positioned on the battery so that it is visible outside of the battery. In one aspect, the indicator light 150 may be an LED light.

A number of the components and control elements suitable for use in aspects of a battery mount monitor assembly of the current disclosure are described in described in U.S. Pat. No. 10,326,171, entitled INTELLIGENT MONITORING SYSTEMS FOR LIQUID ELECTROLYTE BATTERIES, issued Jun. 18, 2019, to Herrema et al.; U.S. Pat. No. 10,381,693, entitled LIQUID LEVEL SENSOR FOR BATTERY MONITORING SYSTEMS, issued Aug. 13, 2019, to Herrema et al.; and U.S. Pat. No. 10,811,735, entitled BATTERY ELECTROLYTE LEVEL MONITOR , SYSTEM , AND METHOD, issued Oct. 20, 2020, to Fox et al., which are all hereby incorporated by reference in their entireties.

The battery mount monitor assembly 100 as depicted in FIG. 1 and the installation process described above is specifically configured for use with lead-acid, industrial vehicle batteries. However, this disclosure is not limited to use with lead-acid, industrial vehicle batteries. In addition, other aspects of a battery mount monitor assembly 100 with different components and/or different component configurations may be used with the battery monitoring technology disclosed herein.

FIG. 3 shows a schematic diagram of a battery rotation system 300 according to one aspect. The battery monitor control module 170 may include a controller 310, a local wireless communication module 320, an on-board mobile communication module 330, an analog-to-digital converter (“ADC”) 340, a temperature sensor 350, and conditioning circuitry 360. Additionally, or alternatively, the temperature sensor 350 may be located inside of the battery. For example, the temperature sensor 350 may be incorporated into the probe 140 which may be inserted into the battery. When located inside of the battery, the temperature sensor 350 can be wired to the battery monitor control module 370 (e.g. to the controller 310) and may communicate that way, or the temperature sensor 350 may communicate wirelessly to the battery monitor control module 370 through any suitable communication protocol. The controller 310 may also be referred to as a battery monitor controller central processing unit (“CPU”). The controller 310 may be electrically connected to the local wireless communication module 320, the on-board mobile communication module 330, the ADC 340, and the indicator light 150. The ADC 340 can be electrically connected to the conditioning circuitry 360 and the temperature sensor 350. The ADC 340 can receive the battery temperature from the temperature sensor 350 and can forward the battery temperature to the controller 310. In an alternate aspect, the controller 310 may receive the battery temperature directly from the temperature sensor 350. The conditioning circuitry 360 may be connected to the current sensor 110 and the power leads 120. The conditioning circuitry 360 may condition (e.g. filter, scale) the signals received from the current sensor 110 and the power leads 120 so that the signals can be read by the ADC 340. The ADC 340 may pass the current and voltage values received from the current sensor 110 and the power leads 120 to the controller 310. In an alternate aspect, the controller 310 may receive the signals from the conditioning circuitry 360 or directly from the current sensor 110 and the power leads 120.

The battery mount monitor assembly 100 can measure current in the battery and the direction of the current (e.g. into or out of the battery) (using the current sensor 110), the voltage across the battery terminals (using the power leads 120), and the temperature of the surface of the battery in the time domain (using the temperature sensor 350). The battery mount monitor assembly 100 may collect current flow and voltage of the battery. In one aspect, the battery mount monitor assembly 100 may measure other characteristics of the battery.

The local wireless communication module 320 may be communicatively coupled to a network connected gateway 200. Both the network connected gateway 200 and the mobile communication module 330 can be communicatively coupled to an external server 370. The external server 370 may have a memory, controller, and other suitable components. The battery mount monitor assembly 100 can communicate with the network connected gateway 200 when it is within a range established by the wireless communication protocol used by the local wireless communication module 320. In one aspect, the battery mount monitor assembly 100 can communicate with the external server 370 at any time using the on-board mobile communication module 330. In an alternate aspect, only the network connected gateway 200 or only the on-board mobile communication module 330 may be communicatively coupled to the external server 370. The external server 370 may be communicatively coupled to a user device 380. For example, the user device 380 may be at least one of a web portal, a mobile app, or a personal computer. The user device 380 can notify a user of the state and operations of the battery rotation system 300 and of the individual battery mount monitor assemblies 100.

In FIG. 8, an exemplary battery rotation system 800 is shown. The battery rotation system 800 may include multiple batteries 810 and each battery 810 can have a unique battery identifier (“battery ID”). The battery mount monitor assemblies 100 may communicate with the network connected gateway 200 and the external server 370. The network connected gateway 200 and the external server 370 can also communicate with each other. The external server 370 may communicate with a plurality of user devices 380. By having multiple battery mount monitor assemblies 100 in one battery rotation system, the external server 370 can use the information from the set of batteries 810 in the battery rotation system 800 to perform analytics, control the function of the battery rotation system 800, and alert the user via the user device 380 of various conditions of the battery rotation system 800. In one aspect, the battery mount monitor assembly 100 can directly communicate with the user device 380. In another aspect, the battery mount monitor assembly 100 may communicate with the network connected gateway 200, the external server 370, and the user device 380.

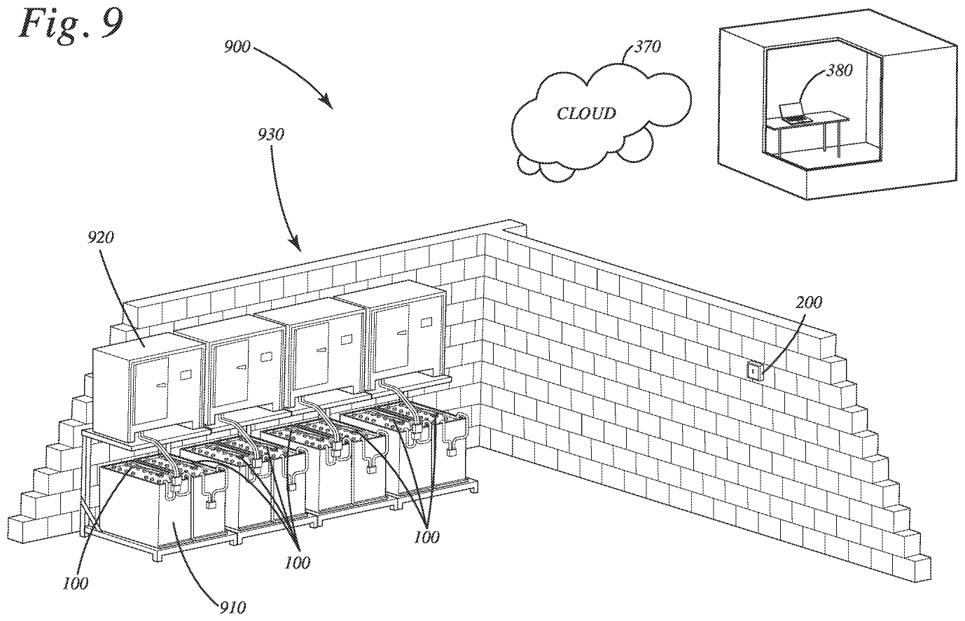

In FIG. 9, a perspective view of an exemplary battery rotation system 900 according to one aspect is shown including an exemplary charging facility 930. The charging facility 930 can include a charging station 920 made up of individual chargers. Each individual charger can accommodate one battery 910 at a time. Several batteries 910 may be installed at the charging station 920 and each battery 910 may have a battery mount monitor assembly 100 installed on it. As depicted, the first, third, fifth, and seventh batteries 910 are connected and charging and the remaining batteries 910 are not charging. The remaining batteries 910 may be “ready for use,” “fully charged,” or awaiting a charge. The charging facility 930 can also include a network connected gateway 200. At least one of the battery mount monitor assemblies 100 and the network connected gateway 200 may communicate with the external server 370. The external server 370 can communicate with the battery mount monitor assemblies 100, the network connected gateway 200, and/or the user device 380.

Monitoring the battery through the battery mount monitor assembly 100 can have a less expensive initial installation cost than monitoring the battery through a monitor installed in the charger because the battery mount monitor assembly 100 is designed to be installed in a battery whereas the charger would need to be retrofit to accommodate a monitor. The battery mount monitor assembly 100 may also be easier to install than hardwiring circuitry into each individual charger. The charger may alternatively be referred to as a charging circuit or charging circuitry.

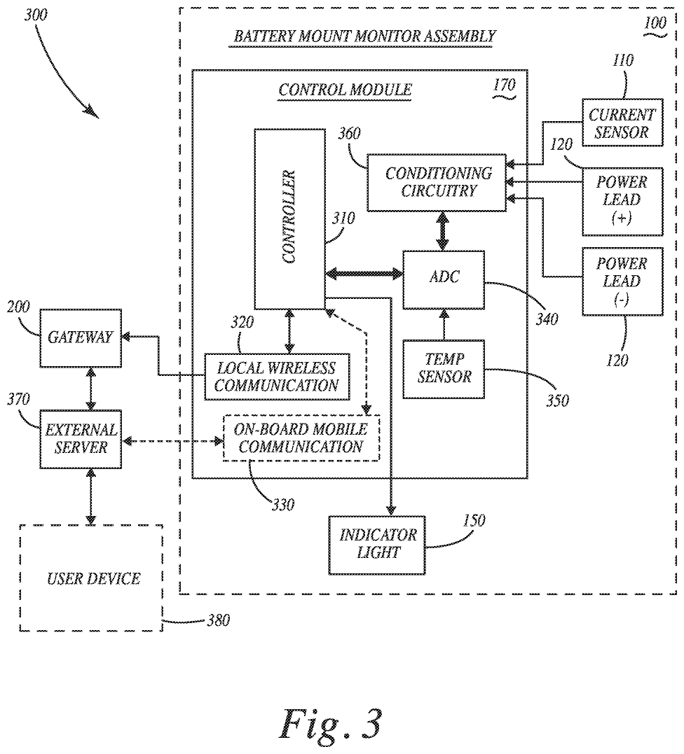

During a battery charging cycle, current flows into the battery and the voltage measured across the leads of the battery are greater than an open circuit voltage. Once the current has stopped entering the battery and the open circuit voltage has returned to within a set range for a fully charged, battery; the battery charging cycle is complete. The battery mount monitor assembly 100 measures these characteristics and determines when the charging cycle is complete. The battery mount monitor assembly 100 measures the temperature of the battery and determines when the battery has returned to a temperature below a set point. When the battery reaches a temperature below the set point, the battery is ready to be used again. The battery mount monitor assembly 100 may alert a user that the battery is ready for use by lighting indicator light 150 or communicating to the user device 380. The indicator light 150 can serve as a physical signal to a user that the battery is ready for use. In one aspect, the indicator light 150 may light up a specific color (e.g. green or white) to indicate the battery is ready for use. Additionally, or alternatively, the battery mount monitor assembly 100 may notify a user through sending a “ready to use” signal to the network connected gateway 200 (described in more detail below with reference to FIGS. 2-4). In another aspect, the “ready to use” signal can be referred to as a “ready to pick” signal. This may be done through any suitable communication protocol, including the Internet of Things (“IoT”). For example, the battery mount monitor assembly 100 may communicate with the network connected gateway 200 through Bluetooth.

In FIG. 2, a perspective view of the network connected gateway 200 according to one aspect is shown. The network connected gateway 200 may be placed in any suitable location in a charging facility at which it can communicate with the plurality of battery mount monitor assemblies 100. In one aspect, the network connected gateway 200 may be powered by a battery included in housing 210. Additionally, or alternatively, the network connected gateway may be powered through an external power source, for example, a power outlet.

One advantage of the present disclosure is that the wireless communication between the network connected gateway 200 and the battery mount monitor assembly 100 means there is no need for hardwired connections between the network connected gateway 200 and the battery mount monitor assembly 100. This makes the battery rotation system easier to install and eliminates hardwired connections to the battery mount monitor assembly 100 as a point of failure. The wireless communication may also allow the battery mount monitor assemblies to be installed over time instead of requiring a whole new system for a battery charging facility to be installed at once. Individual batteries can be transitioned to use the battery mount monitor assemblies 100 one at a time so the new battery rotation system can be adopted over time. The network connected gateway 200 may allow for battery mount monitor assemblies 100 to be added to new or existing industrial batteries as budget and installation time allows, which may ease the financial burden as well as the labor burden of adopting a new system. The entire system can be installed all at once, but it does not need to be.

The wireless communication between the plurality of battery mount monitor assemblies 100 and the network connected gateway 200 may allow the entire battery rotation system to be moved by simply moving the network connected gateway 200 and moving the chargers separately. If the battery mount monitor assemblies 100 were hardwired to the network connected gateway 200 and the battery rotation system 300 needed to be moved to a new location, the entire battery rotation system 300 would need to be disassembled and reassembled in the new location. Moving the battery rotation system disclosed herein may simply require unplugging the network connected gateway 200 and plugging it back in in the new location with different chargers without requiring any additional infrastructure changes.

The wireless communication of the battery rotation system 300 may allow the system to adjust to changes to the system without requiring additional infrastructure. For example, a failed charger can be replaced with a new charger without any changes to the battery rotation system because the battery mount monitor assemblies 100 are installed on the batteries themselves (instead of the chargers) and there is no hardwired connection between the assemblies 100 and the network connected gateway 200. As another example, a new battery with a battery mount monitor assembly 100 installed can be added to the battery rotation system without needing to be wired in.

The network connected gateway 200 may communicate the ready to use signal to an external server 370. In one aspect, the external server 370 is a cloud server. The external server may create a queue of available batteries. The external server 370 can send the queued of available batteries to the user device 380. The queue of available batteries can allow the user to identify which and how many batteries are ready for use.

The battery mount monitor assembly 100, the network connected gateway 200, and the external server 370 may include one or more microcontrollers, microprocessors, and/or other programmable electronics that are programmed to carry out various functionality relating to the battery rotation system which is described herein. The battery mount monitor assembly 100, the network connected gateway 200, and the external server 370 may additionally or alternatively include other electronic components that are programmed to carry out the functions described herein, or that support the microcontrollers, microprocessors, and/or other electronics. The other electronic components can include, but are not limited to, one or more field programmable gate arrays, systems on a chip, volatile or nonvolatile memory, discrete circuitry, integrated circuits, application specific integrated circuits (ASICs) and/or other hardware, software, or firmware. Such components can be physically configured in any suitable manner, such as by mounting them to one or more circuit boards, or arranging them in another manner, whether combined into a single unit or distributed across multiple units. Additionally, the battery mount monitor assembly 100, the network connected gateway 200, and the externals server 370 may communicate using any suitable communication protocol. Some example communication protocols include Wi-Fi, Bluetooth Low Energy (“BLE”), and IoT.

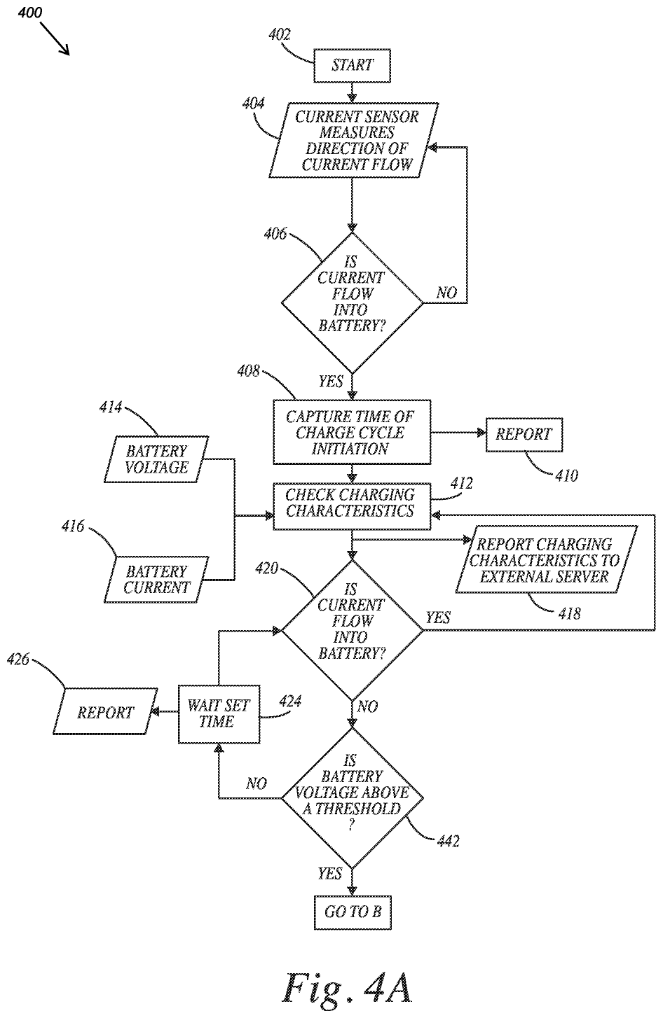

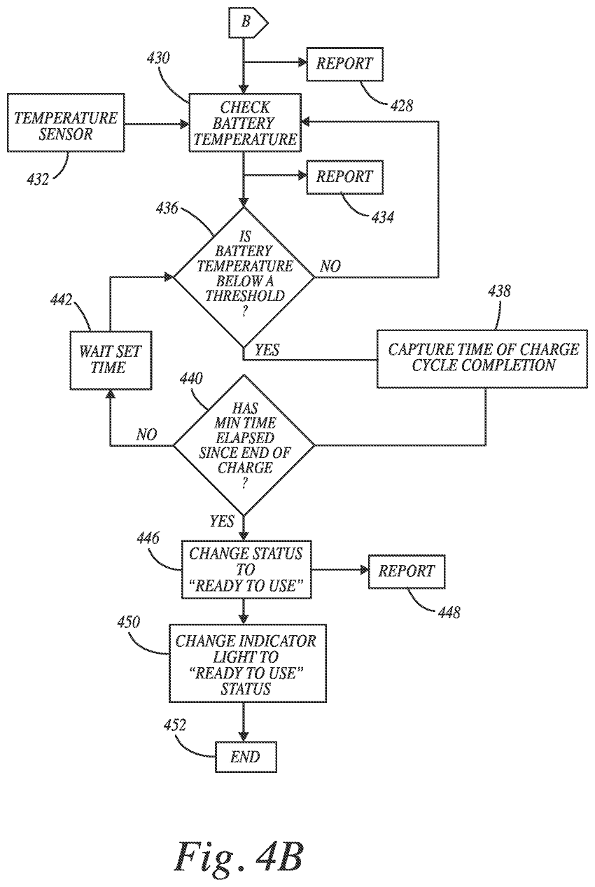

FIGS. 4A-4B show an algorithm 400 for operating the battery rotation system 300 according to one aspect. The algorithm 400 may be performed by the controller 310. In FIG. 4A, the algorithm 400 starts at step 402 and illustrates what may happen when a battery with a battery mount monitor assembly 100 is installed on a battery and the battery is on a charger as shown in one aspect in FIG. 9. Returning to FIG. 4A, at step 404, the current sensor 110 can measure the direction of current flow. The direction of current flow may be sent to the controller 310 and the controller 310 may proceed to step 406. At step 406, the controller 310 may determine whether the current is flowing into the battery. If the current is not flowing into the battery (meaning the battery is not being charged), the controller 310 may return to step 404. If the current is flowing into the battery (indicating the battery is being charged), the controller 310 can proceed to step 408. At step 408, the controller 310 may capture the time of the charge cycle initiation. The controller 310 may report the start of charge to the external server 370 (step 410). It should be understood that references throughout the disclosure to the controller 310 sending information to the external server 370 may be done directly through the on-board mobile communication module 330 or indirectly by sending the information through the local wireless communication module 320 to the network connected gateway 200 and the gateway 200 can forward the information to the external server 370. Additionally, or alternatively, the controller 310 may report the different status events directly to the user device 380. In one aspect, the controller 310 may report locally using the indicator light 150 or a display screen. The display screen (not shown) may be on the charger or on the battery monitor control module 170.

The external server 370 can use the start of charge event to change the state of the battery in its memory to “charging.” This state means that the battery is currently unavailable to be used in a vehicle. The external server 370 can also use the start of charge event to project when the battery will be available for use. The external server 370 can relay the change in battery state to the user device 380.

Returning to FIG. 4A, the controller 310 may then check the charging characteristics of the battery (step 412). Charging characteristics of the battery can be checked by measuring the battery voltage (step 414) by checking the voltage across the power leads 120 and/or by measuring the current entering the battery (step 416) using the current sensor 110. The controller 310 may report the charging characteristics to the external server 370 (step 418) and proceed to step 420. The external server 370 can use the charging characteristics to determine whether the battery is currently being charged, how full the battery is, and an estimate of when the battery will be finished charging. The external server 370 can also use the charging characteristics to determine whether the charging event is proceeding as expected, and may alert the user by sending a notification to the user device 380 if the charging event is abnormal.

At step 420 (FIG. 4A), the control 310 may determine whether current is flowing into the battery (using the current sensor 110) to determine whether the battery is still charging. If the current is flowing into the battery, the controller 310 may return to step 412. If the current is not flowing into the battery, the controller 310 can proceed to step 422. At step 422, the controller 310 may determine if the battery voltage is above a set threshold. The controller 310 can determine the voltage of the battery by receiving the voltage information from the power leads 120. The threshold may be set for each type of battery and/or for each individual battery, and the threshold can be the voltage at which the battery is considered fully charged. If the battery voltage is above the threshold, the charging event occurred as expected and the controller 310 may proceed to step 428 (FIG. 4B). If the battery voltage is below the threshold, the controller 310 may wait a set time (step 424). The controller 310 may report a fault to the external server 370 (step 426) and return to step 420. The controller 310 may report a fault to the external server 370 because, under normal operating conditions, the battery should not stop charging unless the battery voltage has reached the set threshold.

The external server 370 can use the fault to determine whether the battery is charging as expected. The external server 370 can send an alert to the user device 380 to notify a user of the error. The external server 370 may maintain a history of the faults and use it to determine whether there is a pattern of faults that may point to an issue with the battery, the charger, or the battery mount monitor assembly 100.

In FIG. 4B, the algorithm 400 continues. The controller 310 may report the end of charge to the external server 370 (step 428) and proceed to step 430. The external server 370 can use the end of charge event to update the battery status information to “fully charged.” In a scenario where the demand for batteries exceeds the queue of available batteries, the external server 370 may alert the user to batteries with the “fully charged” status. “Fully charged” batteries are not “ready to use” batteries because they have not yet cooled to a temperature below the temperature threshold. When a “fully charged” battery is used before it is “ready to use” the ambient temperature of the battery may rise over time which can cause the battery to operate less efficiently, malfunction, or have a reduced battery life. However, “fully charged” batteries may be able to be used when a vehicle cannot wait for a battery in the “ready to use” state.

At step 430 (FIG. 4B), the controller 310 may check the battery temperature. The controller 310 can check the temperature by checking the output of the temperature sensor 350 (step 432). The controller 310 may report the battery temperature to the external server 370 (step 434) and proceed to step 436. The external server 370 can use the battery temperature to report the battery temperature to the user device 380. The external server 370 may additionally, or alternatively, use the battery temperature to determine an amount of time until the battery will be “ready to use” and may report the remaining time to the user device 380.

At step 436 (FIG. 4B), the controller 310 may determine whether the battery temperature is below a set temperature threshold. The temperature threshold may be set as the temperature at which the battery is ready for use, and the temperature threshold may be different for different battery models and/or different individual batteries. If the battery temperature is above the temperature threshold, the controller 310 may return to step 430. If the battery temperature is below the temperature threshold, the controller 310 can proceed to step 438. At step 438, the controller 310 may capture the time of charge cycle completion and proceed to step 440. The external server 370 can use the time of charge cycle completion to determine the time the battery took to complete the charge cycle. This can be an indicator of whether the battery is operating correctly. For example, as a battery ages, it is unable to charge as efficiently and therefore takes longer to charge. Once the time to complete a charge cycle exceeds a threshold, the external server 370 may notify a user that the battery has exceeded its useful life and should be retired. Different battery models will have different expected charging characteristics and expected charging times.

At step 440 (FIG. 4B), the controller 310 may determine whether a minimum time has elapsed since the end of charging. The controller 310 may do so by comparing the captured time of charge cycle completion with the current time. If the minimum amount of time has elapsed, the controller 310 can proceed to step 446. If the minimum amount of time has not elapsed, the controller 310 may wait a set time (step 442) and return to step 436.

At step 446, the controller 310 may change the battery status to “ready to use”. The controller 310 may report the “ready to use” status to the external server 370 (step 448). The external server 370 can use the “ready to use” signal to notify a user that the battery is ready for use via the user device 380. The external server 370 may add the ready for use battery to the queue of available batteries. The controller 310 may change the indicator light to the “ready to use” status. The controller 310 can then proceed to step 452 where the algorithm 400 ends.

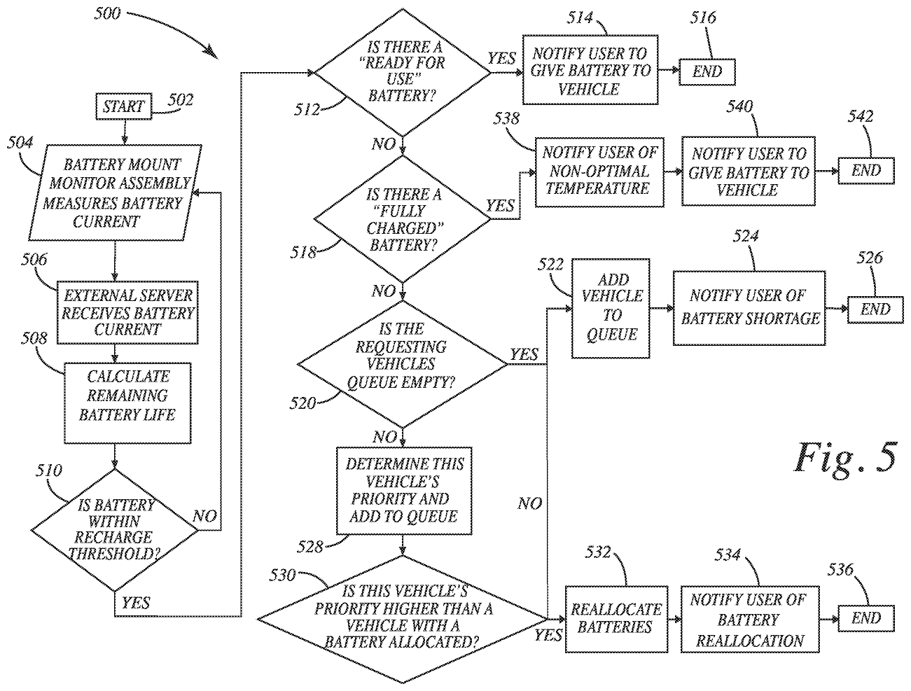

As shown in the algorithms of FIGS. 5-7B, the external server 370 can use cloud-based analytics to improve the battery changing efficiency and the efficiency of the battery rotation system generally.

Cloud-based analytics can be used to schedule when battery changes occur. For example, if multiple vehicles arrive at a charging facility to request a recharged battery at the same time, some of the vehicles may need to wait for a battery depending on the facility. In one aspect, the charging facility may only be able to accommodate one or two battery changes at a time, which may result in vehicles waiting for a battery. In another example, a vehicle may arrive at a charging facility that does not have an available battery and the vehicle must wait for a battery to become available. If vehicles are required to wait for a battery, productivity may be reduced.

In FIG. 5, an algorithm 500 for scheduling battery changes according to one aspect is shown. Put another way, algorithm 500 depicts how the external server 370 can pair when batteries are available with when batteries are used. Algorithm 500 can begin at step 502. At step 504, the battery mount monitor assembly 100 may measure the electrical current out of the battery when the battery is installed in a vehicle by monitoring the current sensor 110. At step 506, the battery mount monitor assembly 100 can forward the data representing the electrical current out of the battery to the external server 370 through the on-board mobile communication module 330. The external server 370 can calculate the remaining life for the battery (step 508) using the measured current out of the battery (step 504) as well as the characteristics of the particular battery and previously measured currents for this battery use cycle. In one aspect, the external server 370 can utilize the battery usage information to identify an amount of time before the battery will need to be replaced. The external server 370 may then proceed to step 510.

At step 510, the external server 370 can determine whether the battery is within a recharge threshold. The recharge threshold may be a range of power levels for the battery at which it is appropriate to recharge the battery. For example, it may not be desirable for the battery to be fully discharged (i.e. dead) or to get too close to being fully discharged because this may result in performance losses for the vehicle. The recharge threshold may be different for different battery models and/or for different individual batteries. If the external server 370 determines the battery is not within the recharge threshold, the external server 370 can return to step 504. If the external server 370 determines the battery is within the recharge threshold, the external server 370 may proceed to step 512.

At step 512, the external server 370 can determine whether there is a battery with the battery status “ready for use.” The external server 370 may do this by checking the queue of available batteries to see if there are any batteries in the queue. If the external server 370 determines there is a “ready for use” battery, the external server 370 may notify a user via the user device 380 to give the particular battery to the vehicle in exchange for the battery within the recharge threshold (step 514). The algorithm 500 may then end (step 516). If the external server 370 determines there are no “ready for use” batteries, the external server 370 may proceed to step 518. At step 518, the external server 370 determines whether there is a battery with the battery status “fully charged.” In one aspect, the external server 370 may keep a queue of fully charged batteries and the external server 370 may check the queue to determine whether there is an available “fully charged” battery. Additionally, or alternatively, the external server 370 may check the battery status of all the batteries in the battery rotation system to determine whether there is an available “fully charged” battery. If the external server 370 determines there is an available “fully charged” battery, the external server 370 may proceed to step 538. If the external server 370 determines there are no available “fully charged” batteries, the external server 370 can proceed to step 520. At step 538, the external server 370 can notify the user via the user device 380 that the available battery has not been sufficiently cooled. In one aspect, the external server 370 may also notify a user via the user device 380 that the battery rotation system has a battery shortage because at least one battery has not been allowed to cool to the desired temperature before being re-installed. At step 540, the external server 370 can notify the user via the user device 380 to give the “fully charged” battery to the vehicle and the algorithm may end (step 542). In one aspect, the battery rotation system may be configured to only allow “ready for use” and not “fully charged” batteries to leave the charging facility and be installed in vehicles. In that case, the external server 370 can skip step 518 and go from step 512 to step 520.

In one aspect, the external server 370 may maintain a requesting vehicles queue by placing a vehicle in the queue when it requests a new battery and removing the vehicle from the queue when it receives a new battery. In an alternative aspect, the external server 370 may remove a vehicle from the requesting vehicles queue when it is assigned a battery rather than when it receives the battery. At step 520, the external server 370 may determine whether there are any vehicles in the requesting vehicles queue. If the requesting vehicles queue is empty, the external server 370 may add the vehicle to the queue (step 522) and notify a user of a battery shortage via the user device 380 (step 524). The algorithm 500 then ends. If the requesting vehicles queue is not empty, the external server 370 can proceed to step 528.

At step 528, the external server 370 may determine this vehicle's priority relative to the vehicles in the requesting vehicles queue and add this vehicle to the requesting vehicles queue. The priority of a given vehicle may be configurable for each battery rotation system. In one aspect, vehicle priority may solely be determined based on the amount of energy remaining in each battery of the vehicles in the queue. In another aspect, vehicle priority may solely be determined based on vehicle function. For example, if a given vehicle is allotted to perform a more desirable task than the other vehicles in the queue, then that vehicle may be moved to the top of the queue of requesting vehicles (e.g. the vehicle will be the next vehicle to receive a battery). In yet another aspect, vehicle priority may be determined solely based on time since the request (i.e. the requesting vehicles queue is a first-in, first-out (“FIFO”) system). In another aspect, vehicle priority may be determined based on any combination of amount of remaining energy, vehicle desirability, time since request, and any other suitable factor. The external server 370 may proceed to step 530.

At step 530, the external server 370 can determine whether this vehicle's priority is higher than a vehicle with a battery allocated to it. Put another way, the external server 370 may determine whether any lower priority vehicles have batteries allocated to them, but have not yet had the allocated battery installed. If the external server 370 determines this vehicle's priority is lower than all vehicles with allocated batteries, the external server 370 may proceed to step 522. If the external server 370 determines this vehicle's priority is higher than at least one vehicle with an allocated battery, the external server 370 may proceed to step 532. At step 532, the external server 370 can reallocate the available batteries so that the vehicle with the highest priority in the requesting vehicles queue receive a battery. The external server 370 may then notify a user of the battery reallocation via the user device 380 (step 534). The algorithm 500 then ends (step 536).

In one aspect, the external server 370 may create a set battery exchange time for the battery. The battery exchange time may be based on the amount of time the battery is in use, the amount of time the battery typically takes to discharge to a charging threshold, the percentage of charge remaining in the battery, or any other suitable factor. Additionally, or alternatively, the external server 370 may send a notification that the battery needs to be changed to the vehicle operator, a battery rotation system manager, or another user through the user device 380. In one aspect, the notification may be a push notification sent to the user through a mobile application of the user device 380.

In one aspect, the battery rotation system 300 may alert an operator of a vehicle using a battery of a specific time or time range to return to the charging facility to exchange the battery currently installed in the vehicle for a “ready for use” battery through the user device 380. For example, such an alert may be generated when the battery in the operator's vehicle is running low, a “ready for use” battery is available, and no other operators are waiting to exchange batteries. The manager of the charging facility may make these exchanges compulsory. In an alternative aspect, the operator may have discretion over whether to exchange the battery at the time or time range provided in the alert.

In one aspect, the battery rotation system 300 may alert an operator of the number of “ready for use” batteries available at the charging facility through the user device 380. The operator can use the alert to determine whether the operator should return to the charging facility to exchange the battery currently in the vehicle.

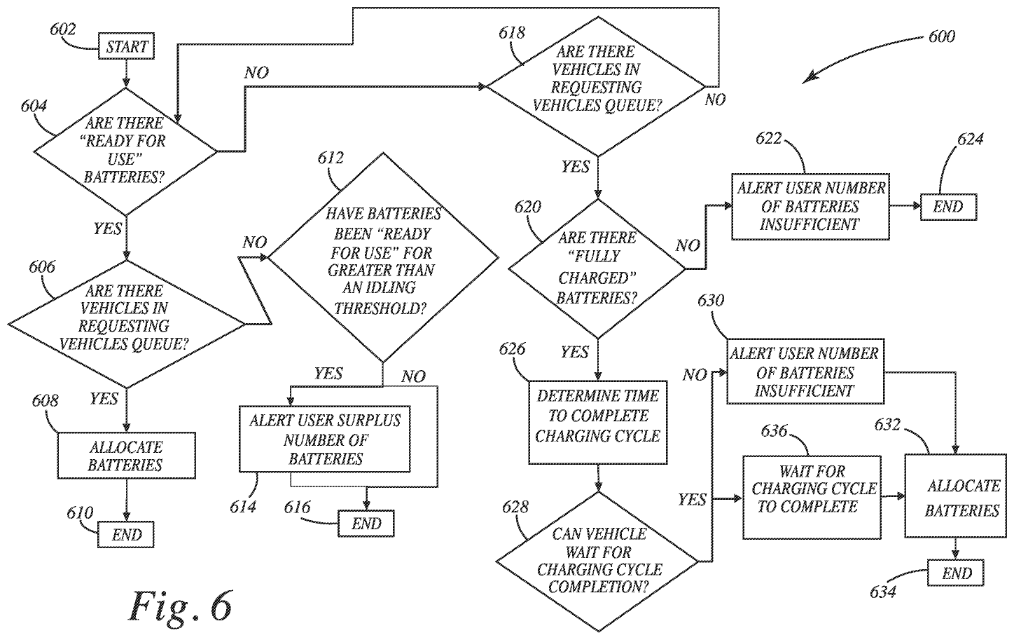

In FIG. 6, an algorithm 600 for determining whether a battery rotation system has a desired number of batteries according to one aspect is shown. The algorithm 600 can start at step 602. At step 604, the external server 370 can determine whether there are any “ready for use” batteries. In one aspect, the external server 370 can determine whether there are any “ready for use” batteries by checking whether there are any batteries in the queue of available batteries. If there are no “ready for use” batteries, the external server 370 may proceed to step 618. If there are “ready for use” batteries, the external server 370 may proceed to step 606. At step 606, the external server 370 can determine whether there are vehicles in the requesting vehicles queue. If there are no vehicles in the requesting vehicles queue, the external server 370 may proceed to step 612. If there is at least one vehicle in the requesting vehicles queue, the external server 370 may allocate the available batteries (step 608) and end the algorithm (step 610).

At step 612, the external server 370 can determine whether batteries have been in the available batteries queue for longer than an idling threshold. The idling threshold may be a maximum amount of time a battery can be “ready for use” without being installed in a vehicle, i.e. the battery is available but is sitting idle rather than being used. Fully charged batteries that are not installed in a vehicle will discharge over time. The idling threshold may be different levels for different battery models and/or for different individual batteries. In one aspect, the idling threshold may be set based on the specific implementation of a given battery rotation system. The idling threshold can be set to balance the demand for batteries with the inefficiency of having fully charged batteries available with no use for them. If at least one battery has been “ready for use” longer than the idling threshold, the external server 370 can alert the user of a surplus number of batteries via the user device 380 (step 614) and end the algorithm (step 616). If no batteries have been “ready for use” longer than the idling threshold, the external server 370 can proceed to step 316 and end the algorithm.

At step 618, the external server 370 may determine whether there are vehicles in the requesting vehicles queue. If there are no vehicles in the requesting vehicles queue, the external server 370 can return to step 604. If there is at least one vehicle in the requesting vehicles queue, the external server 370 can proceed to step 620. At 620, the external server 370 may determine whether there are any “fully charged” batteries. If there is at least one “fully charged” battery, the external server 370 may proceed to step 626. If there are no “fully charged” batteries, the external server 370 may alert a user via the user device 380 that there is an insufficient number of batteries in the battery rotation system (step 622) and end the algorithm (step 624).

At step 626, the external server 370 can determine the time to complete the charging cycle. In one aspect, the external server 370 can estimate the time remaining through historical data of the particular battery. Additionally, or alternatively, the external server 370 may estimate the time remaining by performing a calculation using the current temperature of the battery and the desired temperature at which the battery becomes “ready to use.” In another aspect, the external server 370 may estimate the time remaining by looking up the charge time for that particular battery or its battery model in memory and comparing the charge time with the amount of time the charging cycle has been occurring.

The external server 370 may proceed to step 628 where the external server 370 may determine whether the vehicle can wait for the charging cycle to complete. This determination may be made using a variety of factors including, but not limited to, the amount of energy remaining in the battery currently installed in the vehicle. Put another way, the external server 370 can determine that the batteries are not being allowed to cool to below a set temperature before being re-installed for use which may indicate that the battery rotation system does not have enough batteries to support its operations. If the external server 370 determines the vehicle cannot wait for the charging cycle to complete, the external server 370 can alert a user via the user device 380 that the number of batteries is insufficient and proceed to step 632. In one aspect, the external server 370 may send a different alert than the alert at step 622 and the alert may be that the number of batteries is insufficient, but the batteries are allocable. If the external server 370 determines the vehicle can wait for the charging cycle to complete, the external server 370 can wait for the charging cycle to complete (step 636) and proceed to step 632. At step 632, the external server 370 may allocate the batteries. The external server 370 may then proceed to step 634 where the algorithm 600 ends.

In one aspect, the alert to a user that the number of batteries is insufficient or that there is a surplus of batteries may be in the form of a report on battery usage sent to the user device 380. For example, the report may be sent to a manager of a charging facility to assist them in determining whether the system is running effectively. In one aspect, the alert may include an indication of whether the battery rotation system has an appropriate combination of batteries, i.e. whether the system has an appropriate number of each of the different sizes of batteries in the system for the system's operations.

In one aspect, either or both of the insufficient number of batteries and surplus of batteries alerts can escalate. Put another way, the external server 370 may send one alert the first certain number of times an alert is issued and may send a different alert after the number of alerts within a set period exceeds an alerting threshold. Additionally, or alternatively, the external server 370 may send an increased number of alerts or may send alerts with increased frequency when the alerting threshold is exceeded.

In one aspect, the alert for an insufficient number of batteries can be triggered by the length of time a battery is “ready for use” but has not been installed in a battery falling below the idling threshold. The system may alert that it has a deficit of batteries if at least one battery is consistently being used before reaching the idling threshold because the fact that the battery is not idle for very long can indicate a forthcoming or current deficit of batteries if the length of idle time decreases. In one aspect, the alert for an insufficient number of batteries can be triggered by the overall temperature of the batteries. If the batteries are not being allowed to cool below their ambient temperature before being re-installed in a vehicle, the heat in the battery can increase over time resulting in malfunction of the battery, loss of battery life, or loss of battery efficiency. In one aspect, the alert for an insufficient number of batteries can be triggered by batteries being picked too early, i.e. before their status changes to “ready for use.” In another aspect, the alert for an insufficient number of batteries can be triggered by all of the following: the battery being picked before it reaches the idling threshold, the temperature of the battery, and the batteries being picked early, or any combination of these factors.

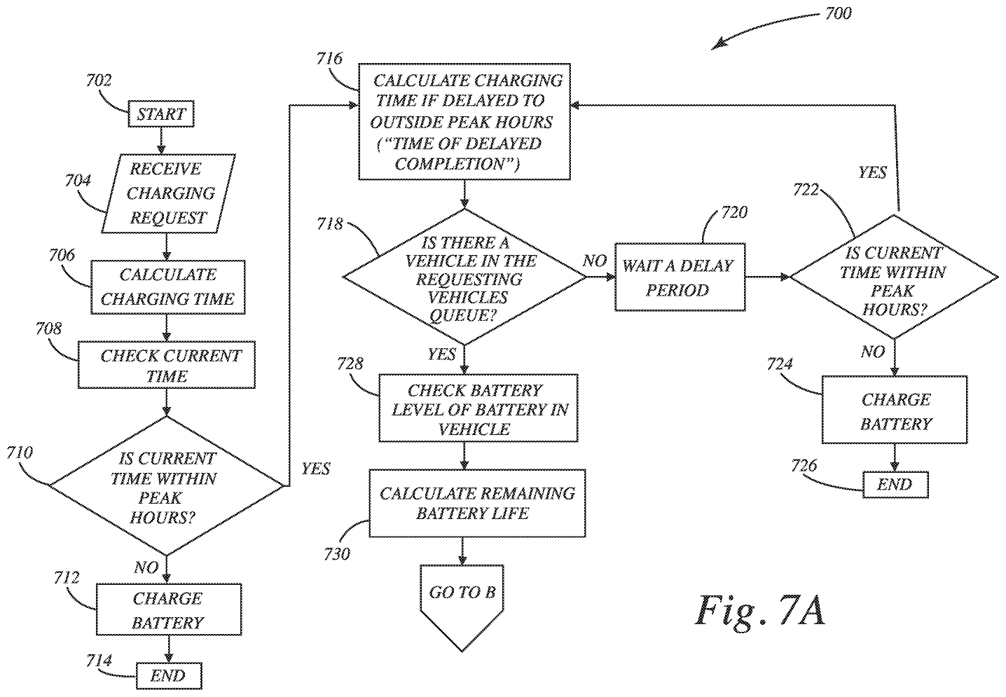

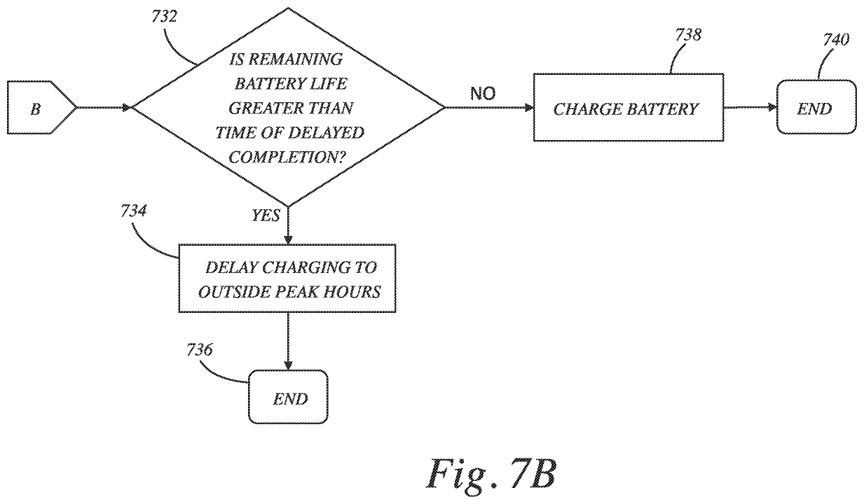

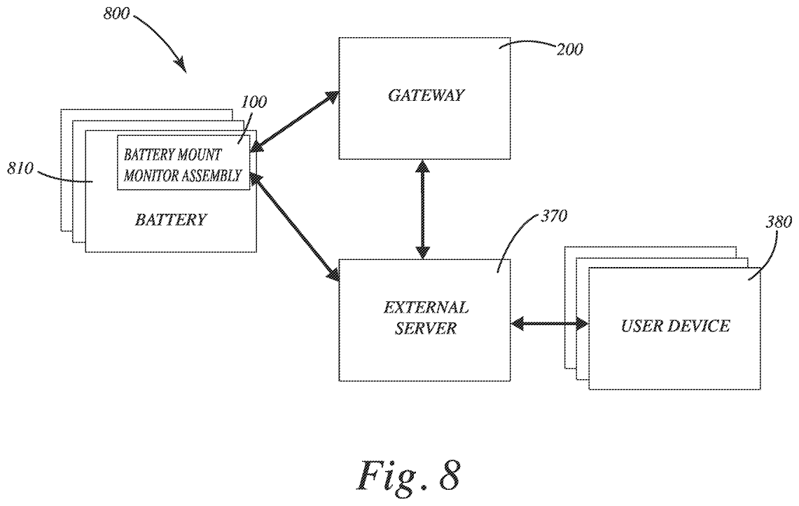

In FIGS. 7A-7B, an algorithm 700 for maximizing off-hour battery charging is shown. The algorithm starts at step 702 and the external server 370 may receive a charging request for a battery. In one aspect, the external server 370 may receive the charging request from the battery mount monitor assembly 100 through the on-board mobile communication module 330. The charging request may come from the battery mount monitor assembly 100 when the battery is installed at a charger or when the battery is installed in a vehicle. If the charging request is sent to the external server 370 when the battery is installed in a vehicle, the external server 370 can add the vehicle to the requesting vehicles queue. In an alternative aspect, the external server 370 may receive the charging request from the network connected gateway 200, and the network connected gateway 200 may receive the charging request from the battery mount monitor assembly 100. At step 706, the external server 370 can calculate the charging time of the battery. In one aspect, the external server 370 can look up the charging time for the given battery or the battery model in a look-up-table stored in the memory. Additionally, or alternatively, the external server 370 can calculate the charging time based on the amount of energy stored in the battery and the energy capacity of the battery. The external server 370 may then proceed to step 708 and check the current time.

At step 710, the external server 370 can determine whether the current time is within a set of peak hours. The set of peak hours may be defined as a length of time when electricity is more expensive during a given day and can vary from region to region. In one aspect, the set of peak hours can be set for the system and be unable to be changed. In an alternate aspect, the set of peak hours may be modifiable, for example, by a user through the user device 380. If the current time is within the set of peak hours, the external server 370 may proceed to step 716. If the current time is not within the set of peak hours, the external server 370 may send a signal to a user via the user device 380 to charge the battery (step 712) and the algorithm 700 ends (step 714). In an alternate aspect, the external server 370 may determine whether the current time is within a threshold of peak hours and may proceed to step 712 and charge the battery even though some of the charging event will occur during peak hours. For example, the threshold may be set at ten minutes, thus if the current time is within 10 minutes of non-peak hours the external server 370 will charge the battery. The threshold may be different for each type of battery in the system or there may be one threshold for the whole system. The threshold can be set to maximize charging in non-peak hours without requiring that the entire charging event be completed during non-peak hours.

In yet another aspect, if the external server 370 determines at step 710 that the current time is within peak hours, the external server 370 may calculate the amount of charge required for a requesting vehicle to complete its tasks. The external server 370 may charge the battery during peak hours to a level sufficient for the vehicle to complete its tasks. This balances the vehicle's need for a battery with the cost of electricity during peak hours by only charging the battery the amount needed for the remaining tasks rather than fully charging the battery. In one aspect, batteries being charged during peak hours can be used to trigger the external server 370 to send a signal via the user device 380 that the system has a deficit of batteries.

Returning to FIG. 7A, at step 716, the external server 370 can calculate the charging time if the charging event is delayed to outside the peak charging hours. This may be referred to as the time of delayed completion. In one aspect, the external server 370 may calculate the charging time by taking into account the current charge of the battery, the amount of energy that will dissipate in the battery between the current time and the non-peak hours, and the amount of time between the current time and the non-peak hours.

At step 718, the external server 370 can determine whether there is a vehicle in the requesting vehicles queue that does not have a battery assigned to it. If there is such a vehicle in the requesting vehicles queue, the external server 370 may proceed to step 728. If there are no such vehicles in the requesting vehicles queue, the external server 370 may wait a delay period (step 720). The delay period can be set based on the particular battery rotation system. For example, the delay period may be 10 minutes when the battery rotation system has many batteries that require rotation throughout the day and does not have a surplus of batteries. In another example, the delay period may be one hour when vehicles are added to the requesting vehicle queue less frequently and the battery rotation system has a surplus of batteries. In yet another example, the delay period may vary throughout the day based on a variety of factors which may include the amount of time between the current time and the set of peak hours, the number of batteries in the queue of available batteries, the demand for this model or capacity of battery, and/or the frequency at which vehicles are added to the requesting vehicles queue.

After waiting the delay period (step 720), the external server 370 can proceed to step 722. At step 722, the external server 370 may check the current time and determine whether the current time is within the set of peak hours. If the current time is within the set of peak hours, the external server 370 may return to step 716. If the current time is not within the set of peak hours, the external server 370 may send a signal to a user via the user device 380 to charge the battery (step 724) and the algorithm 700 may end (step 726).

At step 728, the external server 370 can check the battery level of the battery in the vehicle in the requesting vehicles queue. The external server 370 may then calculate the remaining battery life for that battery (step 370). The remaining battery life may be calculated using the energy differential between the current charge of the battery and the battery being fully discharged and/or the amount of energy the vehicle is expected to use between the current time and the time of delayed completion. At step 732 (FIG. 7B), the external server 370 can determine whether the remaining battery life of the battery currently installed in the vehicle is greater than the time of delayed completion. Put another way, the external server 370 may calculate whether this battery can be charged in non-peak hours and still be ready for use when the battery currently in the vehicle will become fully discharged. If the external server 370 determines the remaining battery life is less than the time of delayed completion, the external server 370 may send a signal to a user via the user device 380 to charge the battery (step 738) and end the algorithm 700 (step 740). If the external server 370 determines the remaining battery life is greater than the time of delayed completion, the external server 370 may delay charging to outside the set of peak hours (step 734) and end the algorithm 700 (step 736). If the demand for the battery is not so great that charging can be delayed, the external server 370 can send a notification to the user via the user device 380 to delay charging the battery until outside of peak hours when electricity is less expensive. As such, the algorithm 700 may reduce the overall cost to charge a battery.

In one aspect, the external server 370 may determine whether a battery can delay charging to non-peak hours by taking into account all of the batteries in the system and the number of batteries needed between the current time and non-peak hours. The external server 370 may be given the number of batteries needed in a given day from a user device 380, or the external server 370 may calculate the number of batteries needed by comparing the work to be completed by the vehicles in the system and the corresponding energy demands with the number of batteries in the system and the electrical capacity of those batteries. The external server 370 can compare the number of “ready for use” batteries with the number of batteries anticipated to be requested between the current time and non-peak hours. If the number of “ready for use” batteries exceeds or is equal to the anticipated requests for batteries and the current time is within the set of peak hours, the external server 370 may send a signal to a user via the user device 380 to delay charging the battery to outside peak hours. If the number of “ready for use” batteries is less than the anticipated requests for batteries and the current time is within the set of peak hours, the external server 370 may send a signal to a user via the user device 380 to charge the battery.

In another aspect, the external server 370 may determine that a battery will be requested in non-peak hours but there will be an insufficient number of batteries available at that time if charging for all batteries that are available to be charged is delayed to non-peak hours. The external server 370 may calculate whether at least a portion of the charge cycle that requires drawing current from a power source can be completed outside of peak hours. For example, a portion of the charge cycle that requires drawing current from a power source cannot be completed outside of peak hours if the time between the start of non-peak hours and the request time is less than the time the battery takes to cool. However, in one aspect, the external server 370 can be configured to consider the charge cycle to only include the time it takes for the battery to charge and not the time it takes for the battery to cool. If the external server 370 determines that at least a portion of the charge cycle that requires the battery to draw current from a power source can be completed outside of peak hours, the external server 370 can send a signal to a user via the user device 380 to delay charging the battery to start at a time which will result in the portion of the charge cycle that can be completed during non-peak hours to be completed during non-peak hours. If not, the external server 370 can send a signal to a user via the user device 380 to charge the battery.

Directional terms, such as “vertical,” “horizontal,” “top,” “bottom,” “upper,” “lower,” “inner,” “inwardly,” “outer” and “outwardly,” are used to assist in describing the invention based on the orientation of the aspects shown in the illustrations. The use of directional terms should not be interpreted to limit the invention to any specific orientation(s).

The above description is that of current aspects of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all aspects of the invention or to limit the scope of the claims to the specific elements illustrated or described in connection with these aspects. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed aspects include a plurality of features that are described in concert and that might cooperatively provide a collection of benefits. The present invention is not limited to only those aspects that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A battery rotation system for rechargeable batteries comprising:
a plurality of battery monitor assemblies, each battery monitor assembly adapted to be connected to a rechargeable battery, each battery monitor assembly including a current sensor, a voltage sensor, a temperature sensor, a monitor processor, and a monitor wireless adapter, each monitor processor configured to receive a current output from the current sensor, a voltage output from the voltage sensor, and a temperature output from the temperature sensor, each monitor processor further configured to generate battery status information indicative of whether the associated battery is ready for use, each battery status information including a unique battery monitor assembly identifier; and
a server including a server wireless adapter in direct or indirect wireless communication with the monitor wireless adapters to receive the battery status information, the server including a server processor configured to receive the battery status information from the server wireless adapter, to maintain queue information in a non-transitory computer-readable medium of the batteries ready for use, and to transmit the queue information by way of the server wireless adapter to a remote user device.

2. The battery rotation system of claim 1 further comprising:
a remote device in wireless communication with the wireless adapters and the server adapter, the remote device configured to wirelessly receive and transmit the battery status information and the queue information between the monitor wireless adapters and the server adapter.

3. The battery rotation system of claim 1 wherein the server processor is further configured:
to receive a request from the remote user device for a number of available batteries;
to determine if the number of requested batteries is available; and
to transmit the determination to the remote user device.

4. The battery rotation system of claim 1 wherein the server processor is further configured:
to schedule a time for at least one of batteries to be replaced as a function of the queue information and the battery status information of the at least one battery; and
to transmit to the time to the remote user device.

5. The battery rotation system of claim 1 wherein the server processor is further configured:
to store information regarding the battery status information of all of the batteries in a vehicle; and
to determine as a function of the battery status information an amount of energy in all of the batteries.

6. The battery rotation system of claim 1 wherein the server process is further configured:
to determine a time of day that a battery is connected to a battery charger as a function of the battery status information;
to compare the time of day to a set of peak hours;
to determine a demand for the battery based on the battery status of other batteries;
to determine to what extent the battery can be charged outside of the set of peak hours as a function of the determined demand for the battery; and
to instruct the battery charger when to charge the battery as a function of the determined extent.

7. A battery rotation system for rechargeable batteries, the system comprising:
a plurality of battery mount monitor assemblies configured to mount to respective rechargeable batteries and each including a housing, a battery terminal connection system configured to electrically connect to rechargeable battery terminals, a current sensor, a voltage sensor, a temperature sensor, a wireless adapter, a processor, and a memory;
a remote device in wireless communication with the wireless adapter, the remote device configured to wirelessly receive and transmit a battery status information; and
a cloud server in wireless communication with the remote device, the cloud server configured to wirelessly receive and transmit a plurality of signals, including the battery status information,
wherein the processor is configured to monitor an output of the current sensor, an output of the voltage sensor, and an output of the temperature sensor and combine that information with a set of information stored in the memory to determine whether a battery is ready for use and to generate the battery status information,
wherein the battery status information includes:
a battery mount monitor assembly identifier; and
a battery status signal,
wherein the wireless adapter transmits the battery status information to the remote device, and
wherein the remote device transmits the battery status information to the cloud server, the cloud server having a non-transitory computer-readable storage medium thereon for executing instructions including:
receiving the battery status information from the remote device;
adding the battery mount monitor assembly identifier to a queue of available batteries in the non-transitory computer-readable storage medium in response to the battery status signal corresponding to a ready for use signal; and
transmitting the queue of available batteries to a remote user device.

8. The system of claim 7 wherein the non-transitory computer-readable storage medium executes instructions further including:
calculating a total of available batteries based on the queue of available batteries;
receiving at least one request for an available battery;
determining whether to fulfil the request based on the total of available batteries; and
transmitting the determination to the remote user device.

9. The system of claim 7 wherein the non-transitory computer-readable storage medium executes instructions further including:
calculating a total of available batteries based on the queue of available batteries;
receiving the battery status information of a battery installed in a vehicle; and
scheduling a replacement time for the battery installed in the vehicle in response to the battery status information and the total of available batteries.

10. The system of claim 9 wherein the non-transitory computer-readable storage medium executes instructions further including:
receiving at least one request for an available battery; and
calculating a number of requested batteries based on the at least one request for a charged battery.

11. The system of claim 7 wherein the non-transitory computer-readable storage medium executes instructions further including:
receiving the battery status information of a system of batteries installed in the vehicle; and
determining an amount of remaining energy in the system of batteries installed in the vehicle.

12. The system of claim 7 wherein the non-transitory computer-readable storage medium executes instructions further including:
calculating a total of available batteries based on the queue of available batteries;
receiving at least one request for an available battery;
calculating a number of requested batteries based on the at least one request for an available battery;
determining a difference between the total of available batteries and the number of requested batteries;
comparing the difference with a set threshold; and
determining based on the comparison whether the system has a surplus of batteries, a deficit of batteries, or a desired number of batteries.

13. The system of claim 7 wherein the non-transitory computer-readable storage medium executes instructions further including:
determining a time of day that a battery is connected to a battery charger based on the battery status information received from the battery mount monitor assembly;
comparing the time of day to a set of peak hours;
determining a demand for the battery in response to at least one request for an available battery;
calculating whether the battery can be charged outside the set of peak hours in response to the demand for the battery; and
instructing the battery mount monitor assembly to delay the battery charger from charging the battery to outside the set of peak hours in response to the demand for the battery allowing for delayed charging.

14. The system of claim 7 wherein each of the respective rechargeable batteries is a lead-acid battery.

15. The system of claim 7 wherein each of the respective rechargeable batteries is an industrial vehicle battery.
